(19) United States
(12) Patent Application Publication
(10) Pub. No.: US 2026/0120585 A1
(43) Pub. Date: Apr. 30, 2026

(54) PERSONALIZED QUESTION AND ANSWER APPARATUS AND METHOD BASED ON DUAL SEARCH AUGMENTED KNOWLEDGE FUSION

(71) Applicant: UIF (UNIVERSITY INDUSTRY FOUNDATION), YONSEI UNIVERSITY, Seoul (KR)

(72) Inventors: Jinyoung Yeo, Seoul (KR); Suyeon Lee, Seoul (KR); Minjin Kim, Seoul (KR); Namyoung Kim, Seoul (KR)

(73) Assignee: UIF (UNIVERSITY INDUSTRY FOUNDATION), YONSEI UNIVERSITY, Seoul (KR)

(21) Appl. No.: 18/933,613

(22) Filed: Oct. 31, 2024

(30) Foreign Application Priority Data
Oct. 24, 2024 (KR) 10-2024-0146874

(51) Int. Cl. G09B 7/02; G06N 3/042

(52) U.S. Cl. CPC G09B 7/02; G06N 3/042

(57) ABSTRACT

Disclosed are a personalized question-and-answer (Q&A) apparatus and method based on dual retrieval-augmented knowledge fusion, and the apparatus includes: a dual retrieval unit configured to perform dual retrieval by concurrently performing instructor knowledge retrieval and student knowledge retrieval regarding a query topic; and a knowledge fusion unit configured to obtain a selected response based on instructor knowledge retrieved through a large language model (LLM) reasoner, establish a plan based on student knowledge retrieved through student knowledge retrieval, and provide a personalized response by performing knowledge fusion that reconstructs the selected response according to the established plan through a response generator.

### CROSS-REFERENCE TO RELATED APPLICATION

This application claims, under 35 U.S.C. § 119 (a), the benefit of Korean Patent Application No. 10-2024-0146874 filed on Oct. 24, 2024, the entire contents of which is incorporated herein by reference.

### TECHNICAL FIELD

The present invention relates to a technology for providing a personalized question-and-answer (Q&A) service, and more specifically, to a personalized Q&A apparatus and method based on dual retrieval-augmented knowledge fusion, which involves performing instructor knowledge retrieval and student knowledge retrieval regarding a query topic, performing knowledge fusion that reconstructs a selected response derived from the instructor knowledge, and providing a personalized response according to student knowledge.

### BACKGROUND

Active interaction between instructors and students, including personalized feedback on student questions, significantly influences academic achievement. When students receive individualized feedback, their understanding of the learning material improves, and self-directed learning is promoted. However, when an instructor has to manage a large number of students, providing personalized responses to each student's question becomes a challenging task.

To address this issue, many educational institutions employ teaching assistants to support instructors. However, teaching assistants also face limitations in providing timely and personalized responses to a large number of students, which leads to significant consumption of manpower and resources.

In this context, there is a growing demand for Virtual Teaching Assistants (VTAs) that allow students to receive personalized tutoring regardless of time or location. In particular, with recent advancements in Large Language Models (LLMs), which have proven to be highly effective in conversational tasks, LLM-based assistants are likely to be utilized as effective VTAs. LLMs may provide immediate responses to student queries and automatically generate feedback tailored to the learner's preferences and needs, thereby enhancing the overall learning experience.

### PRIOR ART LITERATURE

### Patent Document

Korean Patent No. 10-2299563 (Sep. 2, 2021)

### Problem to be Solved

In view of the above, the present disclosure provides a personalized question-and-answer (Q&A) apparatus and method based on dual retrieval-augmented knowledge fusion, which is capable of obtaining instructor knowledge and student knowledge by performing dual retrieval regarding a query topic.

The present disclosure also provides a personalized Q&A apparatus and method based on dual retrieval-augmented knowledge fusion, which is capable of retrieving instructor knowledge using a sparse retriever and a dense retriever.

The present disclosure also provides a personalized Q&A apparatus and method based on dual retrieval-augmented knowledge fusion, which is capable of retrieving student knowledge based on a search of a student's academic performance, major subjects, and past query records.

The present disclosure also provides a personalized question-and-answer (Q&A) apparatus and method based on dual retrieval-augmented knowledge fusion, which is capable of obtaining a selected response based on instructor knowledge and providing a personalized response tailored to the student's knowledge level using the obtained selected response.

### Solution

In one aspect, there is provided a personalized question-and-answer (Q&A) apparatus based on dual retrieval-augmented knowledge fusion, and the apparatus includes: a dual retrieval unit configured to perform dual retrieval by concurrently performing instructor knowledge retrieval and student knowledge retrieval regarding a query topic; and a knowledge fusion unit configured to obtain a selected response based on instructor knowledge retrieved through a large language model (LLM) reasoner, establish a plan based on student knowledge retrieved through student knowledge retrieval, and provide a personalized response by performing knowledge fusion that reconstructs the selected response according to the established plan through a response generator.

The personalized Q&A apparatus may further include a data setup unit configured to set up an instructor course database in which course materials used for the instructor knowledge are constructed as lecture contents for the instructor knowledge retrieval, and a student query DB in which academic information and past query records used for the academic knowledge are constructed at the student level for the student knowledge retrieval.

The dual retrieval unit may be further configured to retrieve the instructor knowledge using a sparse retriever that evaluates relevance based on matching between words included in the instructor knowledge and words used in the query topic.

The dual retrieval unit may be further configured to retrieve the instructor knowledge using a dense retriever that evaluates relevance based on a semantic similarity between the instructor knowledge and the query topic.

The dual retrieval unit may be further configured to retrieve the student knowledge based on a search of a student's academic performance, major subjects, and past query records.

The knowledge fusion unit may be further configured to retrieve top k lecture segments through a sparse retriever or dense retriever and set the retrieved lecture segments as the instructor knowledge, where k is a natural number.

The knowledge fusion unit may be further configured to evaluate the student's level based on the student's academic performance, major subjects, and past query records, and set the student's level as the student knowledge.

The knowledge fusion unit may be further configured to reconstruct the selected response by connecting to content a student already knows according to the established plan, thereby providing the personalized response.

In another aspect, there is provided a personalized question-and-answer (Q&A) method based on dual retrieval-augmented knowledge fusion, performed in a personalized question-and-answer (Q&A) apparatus based on dual retrieval-augmented knowledge fusion, and the method includes: a dual retrieval step of performing instructor knowledge retrieval and student knowledge retrieval regarding a query topic; and a knowledge fusion step of obtaining a selected response based on instructor knowledge retrieved trough a large language model (LLM) reasoner, establishing a plan based on student knowledge retrieved through the student knowledge retrieval, and providing a personalized response by performing knowledge fusion that reconstructs the selected response according to the established plan through a response generator.

### Effect

The disclosed technology may have the following effects. However, it should not be construed that the scope of the disclosed technology is limited thereby, as it does not imply that a specific embodiment must include all or exclusively the following effects.

In the personalized Q&A apparatus and method based on dual retrieval-augmented knowledge fusion according to one embodiment of the present disclosure, it is possible to obtain instructor knowledge and student knowledge by performing dual retrieval regarding a topic.

In the personalized Q&A apparatus and method based on dual retrieval-augmented knowledge fusion according to one embodiment of the present disclosure, it is possible to retrieve instructor knowledge using a sparse retriever and a dense retriever.

In the personalized Q&A apparatus and method based on dual retrieval-augmented knowledge fusion according to one embodiment of the present disclosure, it is possible to retrieve student knowledge based on a search of a student's academic performance, major subjects, and past query records.

In the personalized Q&A apparatus and method based on dual retrieval-augmented knowledge fusion according to one embodiment of the present disclosure, it is possible to obtain a selected response based on instructor knowledge and providing a personalized response tailored to the student's knowledge level using the obtained selected response.

### BRIEF DESCRIPTION OF THE DRAWINGS

FIG. 1 is a drawing illustrating a personalized question-and-answer (Q&A) apparatus according to one embodiment of the present disclosure.

FIG. 2 is a drawing illustrating the functional configuration of the personalized Q&A apparatus of FIG. 1.

FIG. 3 is a drawing illustrating the system configuration of the personalized question-and-answer apparatus of FIG. 1.

FIG. 4 is a flowchart illustrating a personalized question-and-answer (Q&A) method according to the present disclosure.

FIG. 5 is a drawing illustrating one embodiment of the personalized Q&A apparatus of FIG. 1.

### DETAILED DESCRIPTION

A description of the present disclosure is merely an embodiment for a structural or functional description and the scope of the present disclosure should not be construed as being limited by an embodiment described in a text. That is, since the embodiment can be variously changed and have various forms, the scope of the present disclosure should be understood to include equivalents capable of realizing the technical spirit. Further, it should be understood that since a specific embodiment should include all objects or effects or include only the effect, the scope of the present disclosure is limited by the object or effect.

Meanwhile, meanings of terms described in the present application should be understood as follows.

The terms “first,” “second,” and the like are used to differentiate a certain component from other components, but the scope of should not be construed to be limited by the terms. For example, a first component may be referred to as a second component, and similarly, the second component may be referred to as the first component.

It should be understood that, when it is described that a component is “connected to” another component, the component may be directly connected to another component or a third component may be present therebetween. In contrast, it should be understood that, when it is described that an element is “directly connected to” another element, it is understood that no element is present between the element and another element. Meanwhile, other expressions describing the relationship of the components, that is, expressions such as “between” and “directly between” or “adjacent to” and “directly adjacent to” should be similarly interpreted.

It is to be understood that the singular expression encompasses a plurality of expressions unless the context clearly dictates otherwise and it should be understood that term “include” or “have” indicates that a feature, a number, a step, an operation, a component, a part or the combination thereof described in the specification is present, but does not exclude a possibility of presence or addition of one or more other features, numbers, steps, operations, components, parts or combinations thereof, in advance.

In each step, reference numerals (e.g., a, b, c, etc.) are used for convenience of description, the reference numerals are not used to describe the order of the steps and unless otherwise stated, it may occur differently from the order specified. That is, the respective steps may be performed similarly to the specified order, performed substantially simultaneously, and performed in an opposite order.

The present disclosure can be implemented as a computer-readable code on a computer-readable recording medium and the computer-readable recording medium includes all types of recording devices for storing data that can be read by a computer system. Examples of the computer readable recording medium may include a ROM, a RAM, a CD-ROM, a magnetic tape, a floppy disk, an optical data storage device, and the like. Further, the computer readable recording media may be stored and executed as codes which may be distributed in the computer system connected through a network and read by a computer in a distribution method.

If it is not contrarily defined, all terms used herein have the same meanings as those generally understood by those skilled in the art. Terms which are defined in a generally used dictionary should be interpreted to have the same meanings as the meanings in the context of the related art, and are not interpreted as ideal meanings or excessively formal meanings unless clearly defined in the present application.

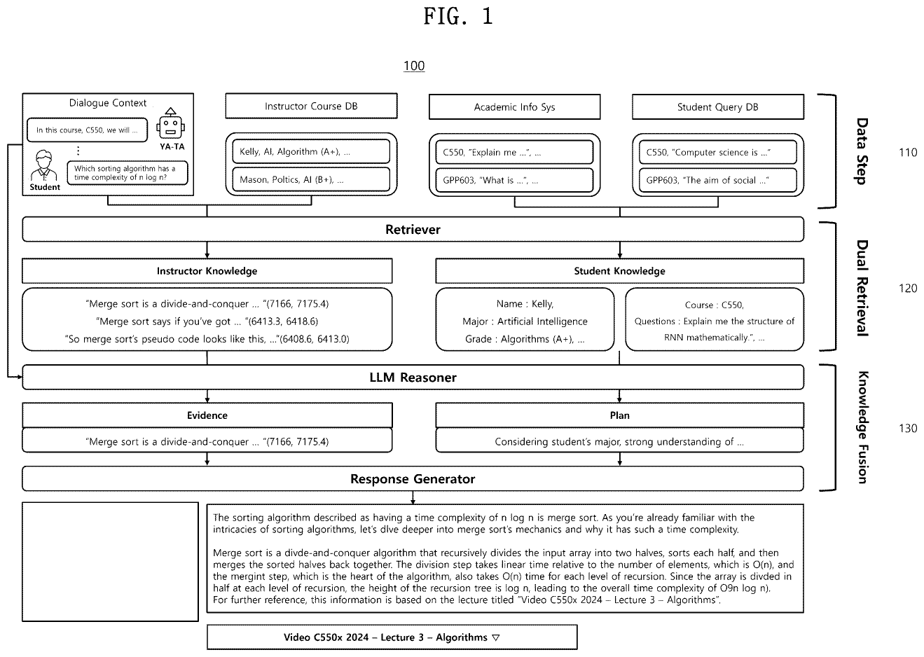

FIG. 1 is a drawing illustrating a personalized question-and-answer (Q&A) apparatus according to one embodiment of the present disclosure.

Referring to FIG. 1, a personalized question-and-answer (Q&A) apparatus 100 may include a data setup unit 110, a dual retrieval unit 120, and a knowledge fusion unit 130.

The personalized Q&A apparatus 100 may generate personalized responses by integrating the knowledge of instructors and students based on the Dual Retrieval-augmented Knowledge Fusion (DRAKE) framework. Here, the personalized Q&A apparatus 100 may generate personalized responses by integrating instructor knowledge and student knowledge based on Equation 1. Equation 1 is as follows:

$${r}_{t} = f ( {D}_{t} , {K}_{I} , {K}_{S} ) \qquad [ Equation 1 ]$$

Here, dialogue context may correspond to Dₜ, which, for example, may be expressed as Dₜ={q₁, r₁, . . . , τₜ₋₁, qₜ}. Instructor knowledge may correspond to K₁, student knowledge may corresponds to K_{S}, and a knowledge fusion module is represented by f(−). The personalized Q&A apparatus 100 may provide personalized Q&A service by concurrently performing instructor knowledge retrieval and student knowledge retrieval through the DRAKE framework and integrating responses using the knowledge fusion module.

The personalized Q&A apparatus 100 may extract audio and text from video data such as a lecture video. Here, the personalized Q&A apparatus 100 may convert video data into text segments using a pre-existing automatic speech recognition model. The pre-existing automatic speech recognition model may correspond to a speech recognition system that has been pre-trained on large-scale speech and text data. During the conversion of the video data into text segments, personalized Q&A apparatus 100 may also generate timestamps indicating the start and end times of the video data. In addition, the personalized Q&A apparatus 100 may categorize video data for each instructor and store the categorized video data in an instructor course database (DB). Alternatively, the personalized Q&A apparatus 100 may categorize video data for each lecture and store such categorized video data in the instructor course DB.

In one embodiment, the data setup unit 110 may store each student's academic performance data in a student query database (DB), including each student's name, major, semester, and grades (e.g. A+, B−, etc.) of all courses enrolled in the past. This academic performance data may be acquired by interfacing with institutional systems (e.g., university academic information systems) or by receiving transcripts from users. The personalized Q&A apparatus 100 may also store queries (e.g., reports, etc.) submitted by each student during a specific course in the student query DB. These queries may be collected across multiple sessions, and the student's understanding level for the specific course may be assessed based on the collected queries.

The personalized Q&A apparatus 100 may generate a response by performing a search on the instructor course DB and the student query DB by the dual retrieval unit 120. Here, the personalized Q&A apparatus 100 may load specific segments corresponding to a specific course from the instructor course DB. In addition, the personalized Q&A apparatus 100 may load academic performance data and queries submitted during the specific course from the student query DB. By doing so, the personalized Q&A apparatus 100 may establish the student knowledge DB and provides a personalized Q&A service tailored to each student's knowledge level. For example, as shown in FIG. 1, when a student named Kelly asks a question about the CS50 course, the personalized Q&A apparatus 100 may retrieve one or more relevant segments from the instructor course DB and academic records and query logs from the student query DB to generate a personalized response.

The personalized Q&A apparatus 100 may generate a response resulting from the integration of instructor knowledge and student knowledge using the knowledge fusion unit 130. The personalized Q&A apparatus 100 may abstract the instructor and student knowledge using a large language model (LLM). For instance, the personalized Q&A apparatus 100 may extract relevant segments containing a lecture topic from the instructor's audio and text using the LLM. In addition, the personalized Q&A apparatus 100 may also convert student knowledge, including transcripts and query records, into a plan using the LLM. Additionally, the personalized Q&A apparatus 100 may convert the student knowledge, including the transcripts and queries, into a plan based on a large-scale language model. The segments and plan may then be fed into a response generator to generate the student's personalized response based on the lecture topic.

Experiments are conducted to assess the effectiveness of the DRAKE framework in achieving personalization for both instructors and students. Here, two complementary methods are used: 1) G-Eval (Liu et al., 2023) for quantitative assessment of YA-TA's responses across multiple criteria, and 2) case studies for qualitative analysis of the DRAKE framework.

### 1. Experimental Setup

To assess the personalized Q&A apparatus 100, a test set is generated by simulating a scenario in which students with diverse academic backgrounds ask various questions about a lecture, and the personalized Q&A apparatus 100 provides a response to each question. An English course for computer science (CS50 from Harvard University) is selected as a testbed. Then, potential questions are extracted from the lecture using GPT-3.5-Turbo. One of the authors, who is a CS expert, has filtered 10 high-quality questions from those potential questions extracted by GPT-3.5-Turbo. In addition, profiles are created for five students with various majors and academic backgrounds. Since each question is matched with multiple student profiles, 50 test sets are generated, each consisting of a query, student knowledge, and instructor knowledge.

Two baselines are set using GPT-3.5-Turbo and GPT-40, both of which are provided with only dialogue context without any retrieved knowledge. An ablation study is also conducted to investigate the effect of each type of knowledge, and the model is then instructed to generate responses to queries based on the test sets.

### 2. Evaluation Criteria

Performance was assessed across various criteria using G-Eval, scoring each on a scale from 0 to 5. The instructor-side metrics are as follows: (1) Precision: Does the answer provide necessary information without redundancy? (2) Groundedness: Is the answer aligned with the instructor's statements and teaching philosophy?

The student-side metrics are: (1) Helpfulness: How satisfied is the student likely to be? (2) Comprehensiveness: Does the answer appropriately consider the student's academic ability? Finally, the metrics for both sides are as follows: (1) Overall: Does the response align with the instructor's statements and reflect the student's information?

### 3. G-Eval Results

The experimental results are shown in Table 1. The results show that retrieving information from only one side (instructor or student) outperforms dual retrieval, emphasizing the challenge of achieving personalization on both the instructor and student sides. In addition, when considering both sides together, the DRAKE framework demonstrates strong performance in integrating knowledge from both instructor and student perspectives.

TABLE 1
G-Eval result between YATA and other models. The best results for each
base model are bolded and the second-best result is underlined.

| | | | | | | Criterion for |
|---|---|---|---|---|---|---|
| | | Criteria for Instructor Pers. | | Criteria for Student Pers. | | Both Pers. |
| Model | Method | Precision | Groundedness | Helpfulness | Comprehensiveness | Overall |
| GPT-3.5-Turbo | — | 3.82 | 4.08 | 4.48 | 4.02 | 3.48 |
| GPT-4o | — | 4.12 | 4.04 | 4.6 | 4.16 | 3.5 |
| GPT-3.5-Turbo | +Instructor Knowledge | 4.56 | 4.82 | 4.68 | 4.36 | 3.76 |
| | +Student Knowledge | 3.92 | 4.18 | 4.8 | 4.46 | 3.94 |
| | +DRAKE | 4.3 | 4.66 | 4.7 | 4.4 | 4.06 |

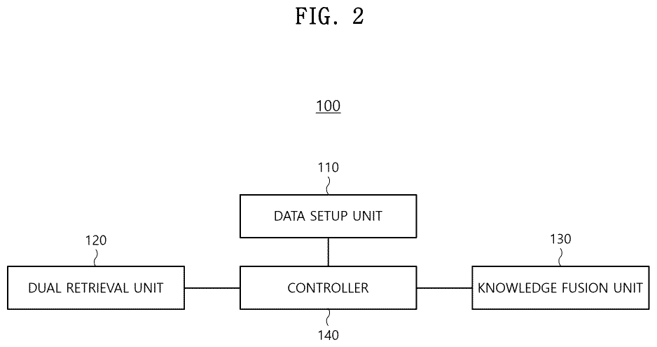

FIG. 2 is a drawing illustrating the functional configuration of the personalized Q&A apparatus of FIG. 1.

Referring to FIG. 2, the personalized Q&A apparatus 100 may include a data setup unit 110, a dual retrieval unit 120, a knowledge fusion unit 130, and a controller 140.

The embodiment of the present disclosure is not limited to including all of these components simultaneously. Depending on each embodiment, some components may be omitted, or some or all of these components may be included selectively. The operations of each component are described in detail below.

The data setup unit 110 may set up an instructor course database (DB) constructed with lecture content for instructor knowledge retrieval and a student query DB constructed with academic information and past query records at students' level for student knowledge retrieval. Here, the data setup unit 110 may convert course materials, such as lecture videos, into lecture content through an abstraction process. For example, the data setup unit 110 may perform the abstraction process based on an automatic speech recognition model to convert course materials via speech-to-text (STT). In doing so, the data setup unit 110 may convert course materials provided by an instructor into a text form and extract keywords to identify key concepts or topics. The data setup unit 110 may construct an instructor course DB by categorizing and storing lecture content for each instructor. Additionally, the data setup unit 110 may store a student's academic information, including the student's name, major, semester, and grades (e.g., A+, B−) for all courses previously taken, as well as past query records, such as reports submitted during a specific course, in a student query DB.

The dual retrieval unit 120 may perform dual retrieval by concurrently performing instructor knowledge retrieval and student knowledge retrieval regarding a query topic. Here, the dual retrieval unit 120 may receive a specific query topic from a user and retrieve information related to the specific topic from the instructor course DB and the student query DB. For example, the dual retrieval unit 120 may load instructor knowledge related to the specific query topic from the instructor course DB and retrieve past query records from the student query DB to assess the student's learning level and generate a response tailored to the level.

In one embodiment, the dual retrieval unit 120 may retrieve instructor knowledge using a sparse retriever that assesses relevance based on matching between words included in the instructor knowledge and words used in the query topic. Here, the sparse retriever may be a technique that assesses relevance based on matching between text words in a document and words used in a question. The dual retrieval unit 120 may perform a comparative analysis between words used in the query topic and words in the instructor course DB, evaluating relevance based on a degree of word matching. In one embodiment, the dual retrieval unit 120 may assign scores based on relevance when comparing words in the query topic with those in the instructor knowledge DB using the sparse retriever. For example, the dual retrieval unit 120 may assess relevance and assign scores according to the location (e.g., title, first paragraph, etc.) of query topic words in the course materials included in the instructor course DB.

In one embodiment, the dual retrieval unit 120 may retrieve instructor knowledge using a dense retriever that assesses relevance based on a semantic similarity between the instructor knowledge and the query topic. Here, the dense retriever may be a technique that derives search results based on the semantic similarity between words. The dual retrieval unit 120 may assess relevance by analyzing the semantic similarity between words included in the instructor knowledge and the query topic, representing them as vectors through embedding techniques. For example, the dual retrieval unit 120 may convert words included in the instructor knowledge and the query topic into vectors and analyze relevance based on cosine similarity between vectors. Here, the dual retrieval unit 120 may analyze a distance between vectors of instructor knowledge words and query topic words based on cosine similarity and assign a relevance score according to the distance.

In one embodiment, the dual retrieval unit 120 may retrieve student knowledge based on a search of the student's academic performance, major subjects, and past query records. Here, during the student knowledge retrieval process, the dual retrieval unit 120 may determine the student's knowledge level based on a search of the student's academic performance, major subjects, and past query records. For example, the dual retrieval unit 120 may assess the level of understanding of a specific query topic based on the academic performance of a specific student and provide responses tailored to the assessed level. Additionally, if there is a record of repeated queries on a specific topic, the dual retrieval unit 120 may evaluate the student's understanding level on that topic as low and provide a response that includes additional explanatory materials tailored to the student's level of understanding.

The knowledge fusion unit 130 may obtain a selected response based on instructor knowledge retrieved through the large language model (LLM) reasoner, establish a plan based on student knowledge retrieved through student knowledge retrieval, and provide personalized responses by performing knowledge fusion through a response generator that reconstructs the selected response according to the established plan. Here, the LLM reasoner may extract the most relevant information from the retrieved instructor knowledge based on a large language model and determine the extracted information as a selected response, while the response generator may restructure the selected response according to the student's level. The knowledge fusion unit 130 may retrieve instructor knowledge related to the query topic using the sparse and dense retrievers based on the LLM reasoner, extract instructor knowledge that matches the query topic, and determine the extracted knowledge as a selected response. Additionally, the knowledge fusion unit 130 may reconstruct the selected response by integrating the student learning level obtained from student knowledge retrieval based on the selected response derived through the LLM reasoner. Through this process, the knowledge fusion unit 130 may provide course materials highly relevant to the student's knowledge level.

In one embodiment, the knowledge fusion unit 130 may select the top k (where k is a natural number) lecture segments retrieved via a sparse retriever or dense retriever and set the selected lecture segments as instructor knowledge. Here, the knowledge fusion unit 130 may select the top k lecture segments with a high frequency of words or keywords matching the query topic based on the sparse retriever. Additionally, the knowledge fusion unit 130 may select the top k course materials that are semantically similar to the query topic based on the dense retriever. In one embodiment, the knowledge fusion unit 130 may load the top k lecture segments based on relevance scores and set the loaded lecture segments as instructor knowledge. The k value may be adjusted based on system settings and may also be modified according to the difficulty level of a specific query topic or the required amount of data.

In one embodiment, the knowledge fusion unit 130 may assess the student's level based on the student's academic performance, major subjects, and past query records, and set the student's assessed level as student knowledge. Here, the knowledge fusion unit 130 may determine the level of understanding of a specific query topic according to the student's academic performance in a particular major subject and generate a response based on the determined level. For example, in evaluating the student's level for a query topic on the “wave equation,” the knowledge fusion unit 130 may determine the student's level based on the student's academic performance in physics-related subjects. Additionally, the knowledge fusion unit 130 may provide new instructor knowledge instead of repeated instructor knowledge based on past query records in specific major subjects.

In one embodiment, the knowledge fusion unit 130 may reprocess the selected response according to the established plan, connecting it to content the student already knows to provide a personalized response. Here, the knowledge fusion unit 130 may analyze the content the student already knows about a specific query topic by retrieving instructor knowledge and student knowledge related to the student's query. For example, the knowledge fusion unit 130 may reprocess the selected response based on the student knowledge, such as academic information and past learning content. In one embodiment, the knowledge fusion unit 130 may expand the content of the selected response and adjust the difficulty level or explanation level of the response according to the student's knowledge level.

The controller 140 may control the overall operation of the personalized Q&A apparatus 100 and manage the control flow or data flow among the data setup unit 110, the dual retrieval unit 120, and the knowledge fusion unit 130.

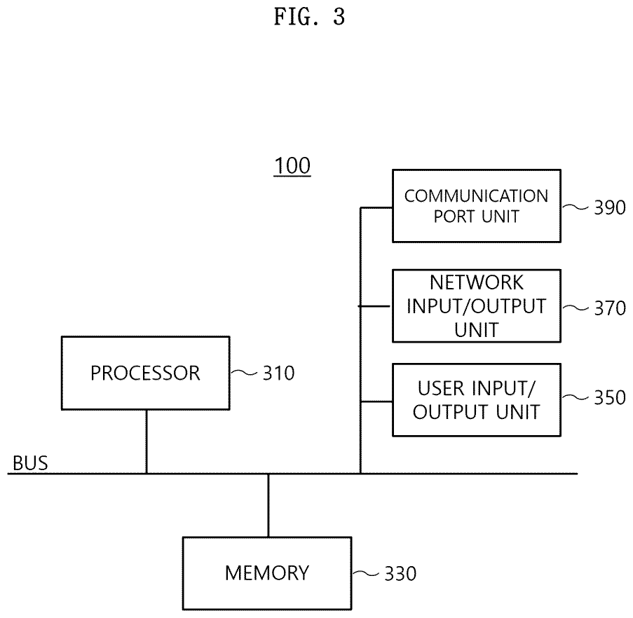

FIG. 3 is a drawing illustrating the system configuration of the personalized Q&A apparatus of FIG. 1.

Referring to FIG. 3, the personalized Q&A apparatus 100 may include a processor 310, a memory 330, a user input/output unit 350, a network input/output unit 370, and a communication port unit 390.

The processor 310 may execute a personalized Q&A service procedure according to an embodiment of the present disclosure, manage a memory 330 to be read or written during the personalized Q&A service process, and schedule a synchronization time between a volatile memory and a non-volatile memory in the memory 330. The processor 310 may control the overall operation of the personalized Q&A apparatus 100, and may be electrically connected to the memory 330, the user input/output unit 350, the network input/output unit 370, and the communication port unit 390 to control a data flow therebetween. The processor 310 may be implemented as a central processing unit (CPU) or graphics processing unit (GPU) of the personalized Q&A apparatus 100.

The memory 330 may include an auxiliary memory device, implemented as a non-volatile memory such as a Solid State Disk (SSD) or Hard Disk Drive (HDD), used to store all data required for the personalized Q&A apparatus 100. The memory 330 may also include a main memory device, implemented as a volatile memory such as Random Access Memory (RAM). In addition, the memory 330 may store a set of commands for executing a method of the personalized question-and-answer apparatus according to the present disclosure, when executed by the electrically connected processor 310.

The user input/output unit 350 may include components for receiving user input and outputting specific information to the user. For example, the user input/output unit 350 may include an input device with adapters such as a touch pad, touch screen, virtual keyboard, or pointing device, and an output device with adapters such as a monitor or touch screen. In one embodiment, the user input/output unit 350 may correspond to a computing device connected via remote access, and in this case, the personalized Q&A apparatus 100 may be performed as an independent server.

The network input/output unit 370 may provide a communication environment for connecting to a user terminal through a network and may include adapters for communication, such as a local area network (LAN), metropolitan area network (MAN), wide area network (WAN), and value added network (VAN). In addition, for the wireless transmission of learning data, the network input/output unit 370 may be implemented to provide a short-range communication function, such as Wi-Fi and Bluetooth, or a wireless communication function of 4G or higher.

The communication port unit 390 may be implemented as a port mapping table that performs data routing during the transmission and reception of data over a network. Here, the communication port unit 390 may differentiate the communication session between the dual retrieval unit 120 and the server by assigning a unique source port to the dual retrieval unit 120, thereby preventing data collision during the process of data transmission and reception.

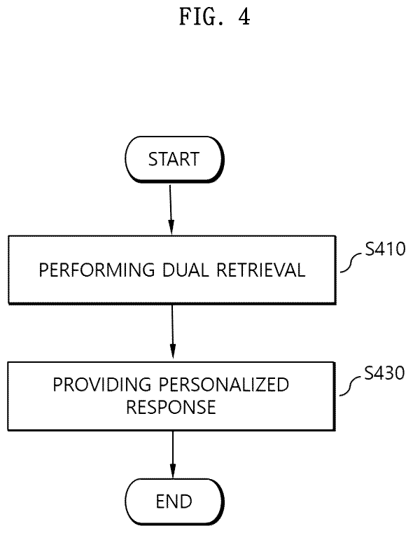

FIG. 4 is a flowchart illustrating a personalized question-and-answer (Q&A) method according to the present disclosure.

Referring to FIG. 4, the personalized Q&A apparatus 100 may perform dual retrieval to concurrently performing instructor knowledge retrieval and student knowledge retrieval regarding a query topic using a dual retrieval unit 120 (S410). Here, the personalized Q&A apparatus 100 may retrieve the instructor knowledge using a sparse retriever and a dense retriever, and retrieve the student knowledge based on a search of a student's academic performance, major subjects, and past query records.

The personalized Q&A apparatus 100 may obtain a selected response based on the instructor knowledge acquired through instructor knowledge retrieval using an LLM reasoner by the knowledge fusion unit 130, establish a plan based on the student knowledge acquired through student knowledge retrieval, and provide a personalized response by performing knowledge fusion that reconstructs the selected response according to the established plan through a response generator (S430).

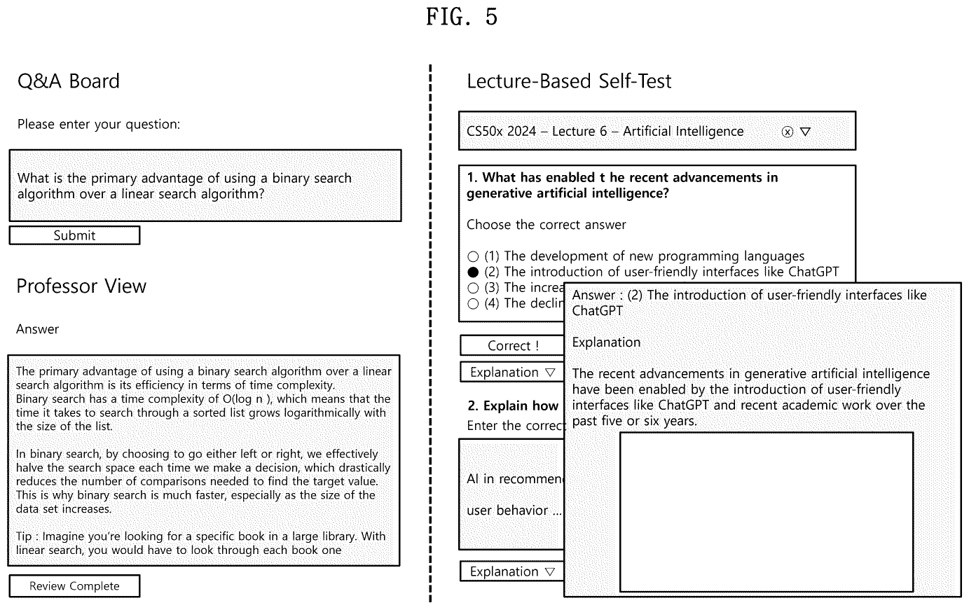

FIG. 5 is a drawing illustrating one embodiment of the personalized Q&A apparatus of FIG. 1.

In FIG. 5, the personalized Q&A apparatus 100 may provide a Q&A board and a self-practice tool that allows a student to perform self-practice to improve the student's the student's learning outcomes. Here, the Q&A board may support deep learning through interaction between instructors and students, and the self-practice tool may serve as a tool that allows self-checking and reviewing of learned content.

In one embodiment, the personalized Q&A apparatus 100 may receive questions from students outside of lecture instruction through the Q&A board and provide additional explanations. For example, a personalized Q&A apparatus 100 may provide a draft response based on instructor knowledge to a question received through a Q&A board. Thereafter, the personalized Q&A apparatus 100 may review the draft response to ensure alignment with the main concept or topic of the lecture, and provide a final response.

In one embodiment, the personalized Q&A apparatus 100 may provide quizzes to allow a student to self-assess his or her understanding of the instructor knowledge based on a self-practice tool. Here, the quizzes may be created focusing on key concepts or topics of the lecture. The personalized Q&A apparatus 100 may assess a specific student's level of understanding of the instructor knowledge, by providing quizzes on the main concept or topic of the lecture based on the instructor knowledge, store the result in the student query DB, and update the student query DB.

The above description is merely exemplary description of the technical scope of the present disclosure, and it will be understood by those skilled in the art that various changes and modifications can be made without departing from the spirit and scope of the present disclosure as set forth in the following claims.

### [National Research and Development Project Supporting The Present Invention]

[Project Serial No] 2710006677
[Task Project No] RS-2020-II201361
[Name of Department] Ministry of Science and ICT
[Task Management (Professional) Institution Name] Institute of Information and Communications Technology Planning and Evaluation
[Research Project Name] Nurturing ICT and Broadcasting Innovation Talents
[Research Task Title] Artificial Intelligence Graduate School Support (Yonsei University)
[Name Of Project Performing Organization] Yonsei University Industry-University Cooperation Foundation
[Research Period] 2024.01.01˜2024.12.31

[Detailed Description of Main Elements]

| | |
|---|---|
| 100: personalized question and | |
| answer (Q&A) apparatus | |
| 110: data setup unit | 120: dual retrieval unit |
| 130: knowledge fusion unit | |
| 140: controller | |
| 310: processor | 330: memory |
| 350: user input/output unit | 370: network input/output unit |
| 390: communication port unit | |

1. A personalized question-and-answer (Q&A) apparatus based on dual retrieval-augmented knowledge fusion, the apparatus comprising:
a hardware memory that store a set of commands for executing operations of the personalized question-and-answer apparatus; and
a hardware processor electrically connected with the memory and configured to:
perform dual retrieval by concurrently performing instructor knowledge retrieval and student knowledge retrieval regarding a query topic; and
obtain a selected response based on instructor knowledge retrieved through a large language model (LLM) reasoner, establish a plan based on student knowledge retrieved through student knowledge retrieval, and provide a personalized response by performing knowledge fusion that reconstructs the selected response according to the established plan.

2. The personalized Q&A apparatus of claim 1, wherein the processor is further configured to set up an instructor course database in which course materials used for the instructor knowledge are constructed as lecture content for the instructor knowledge retrieval, and a student query database in which academic information and past query records used for the academic knowledge are constructed at a student level for the student knowledge retrieval.

3. The personalized Q&A apparatus of claim 1, wherein the processor is further configured to retrieve the instructor knowledge using a sparse retriever that evaluates relevance based on matching between words included in the instructor knowledge and words used in the query topic.

4. The personalized Q&A apparatus of claim 1, wherein the processor is further configured to retrieve the instructor knowledge using a dense retriever that evaluates relevance based on a semantic similarity between the instructor knowledge and the query topic.

5. The personalized Q&A apparatus of claim 1, wherein the processor is further configured to retrieve the student knowledge based on a search of a student's academic performance, major subjects, and past query records.

6. The personalized Q&A apparatus of claim 1, wherein the processor is further configured to retrieve top k lecture segments through a sparse retriever or dense retriever and set the retrieved lecture segments as the instructor knowledge, where k is a natural number.

7. The personalized Q&A apparatus of claim 6, wherein the processor is further configured to evaluate a student's level based on a student's academic performance, major subjects, and past query records, and set the student's level as the student knowledge.

8. The personalized Q&A apparatus of claim 1, wherein the processor is further configured to reconstruct the selected response by connecting to content a student already knows according to the established plan, thereby providing the personalized response.

9. A personalized question-and-answer (Q&A) method based on dual retrieval-augmented knowledge fusion, performed in a personalized question-and-answer (Q&A) apparatus including a memory and a processor electrically connected with the memory, based on dual retrieval-augmented knowledge fusion, comprising:
concurrently performing, by the processor, instructor knowledge retrieval and student knowledge retrieval regarding a query topic; and
obtaining, by the processor, a selected response based on instructor knowledge retrieved through a large language model (LLM) reasoner, establishing, by the processor, a plan based on student knowledge retrieved through the student knowledge retrieval, and providing, by the processor, a personalized response by performing knowledge fusion that reconstructs the selected response according to the established plan.

10. The personalized Q&A apparatus of claim 1, wherein the processor is further configured to generate the personalized response by integrating the instructor knowledge and the student knowledge based on a Dual Retrieval-augmented Knowledge Fusion (DRAKE) framework.

11. The personalized Q&A apparatus of claim 1, wherein the processor is further configured to:
convert a lecture video into text segments using a pre-existing automatic speech recognition model;
generate timestamps indicating start and end times of the lecture video; and
categorize the lecture video for each instructor and store the categorized lecture video in an instructor course database.

12. The personalized Q&A apparatus of claim 1, wherein the processor is further configured to:
store each student's academic performance data in a student query database, wherein the academic performance data include a student's name, major, semester, and grades of all courses previously enrolled.

13. The personalized question-and-answer (Q&A) method of claim 9, wherein the providing the personalized response comprises:
generating the personalized response by integrating the instructor knowledge and the student knowledge based on a Dual Retrieval-augmented Knowledge Fusion (DRAKE) framework.

14. The personalized question-and-answer (Q&A) method of claim 9, further comprising:
converting, by the processor, a lecture video into text segments using a pre-existing automatic speech recognition model;
generate, by the processor, timestamps indicating start and end times of the lecture video; and
categorize, by the processor, the lecture video for each instructor, and storing, by the processor, the categorized lecture video in an instructor course database stored in the memory.

15. The personalized question-and-answer (Q&A) method of claim 9, further comprising:
storing, by the processor, each student's academic performance data in a student query database stored in the memory, wherein the academic performance data include a student's name, major, semester, and grades of all courses previously enrolled.
